(19) United States
(12) Patent Application Publication
(10) Pub. No.: US 2014/0010295 A1
(43) Pub. Date: Jan. 9, 2014

(54) Methods and Apparatus for Geometric-Based Intra Prediction

(71) Applicants: Taoran Lu, Santa Clara, CA (US); Qian Xu, Folsom, CA (US); Joel Sole, La Jolla, CA (US); Peng Yin, Ithaca, NY (US); Yunfei Zheng, San Jose, CA (US); Xiaoan Lu, Princeton, NJ (US)

(72) Inventors: Taoran Lu, Santa Clara, CA (US); Qian Xu, Folsom, CA (US); Joel Sole, La Jolla, CA (US); Peng Yin, Ithaca, NY (US); Yunfei Zheng, San Jose, CA (US); Xiaoan Lu, Princeton, NJ (US)

(73) Assignee: THOMSON LICENSING, Issy de Moulineaux (FR)

(21) Appl. No.: 13/980,789

(22) PCT Filed: Jan. 19, 2012
(86) PCT No.: PCT/US2012/021859

§ 371 Date: Sep. 16, 2013

Related U.S. Application Data
(60) Provisional application No. 61/435,035, filed on Jan. 21, 2011.

(51) Int. Cl. H04N 7/32

(52) U.S. Cl. CPC H04N 19/00569
USPC 375/240.12

(57) ABSTRACT

Methods and apparatus are provided for geometric-based intra prediction. An apparatus includes a video encoder for encoding picture data for at least a portion of a block in a picture by detecting a local geometric pattern in a surrounding area with respect to the portion, and performing at least one of interpolation and extrapolation with respect to an edge direction of the local geometric pattern to generate an intra prediction for the portion.

### CROSS-REFERENCE TO RELATED APPLICATIONS

This application claims the benefit of U.S. Provisional Application Ser. No. 61/435,035, filed Jan. 21, 2011, which is incorporated by reference herein in its entirety.

### TECHNICAL FIELD

The present principles relate generally to video encoding and decoding and, more particularly, to methods and apparatus for geometric-based intra prediction.

### BACKGROUND

The International Organization for Standardization/International Electrotechnical Commission (ISO/IEC) Moving Picture Experts Group-4 (MPEG-4) Part 10 Advanced Video Coding (AVC) Standard/International Telecommunication Union, Telecommunication Sector (ITU-T) H.264 Recommendation (hereinafter the “MPEG-4 AVC Standard”) is the first video coding standard that employs spatial directional prediction for intra coding. The MPEG-4 AVC Standard provides a flexible prediction framework, thus the coding efficiency is greatly improved over previous standards where intra prediction was done only in the transform domain.

In accordance with the MPEG-4 AVC Standard, spatial intra prediction is performed using the surrounding available samples, which are the previously reconstructed samples available at the decoder within the same slice. For luma samples, intra prediction can be done on a 4×4 block basis (denoted as Intra_{—}4×4), an 8×8 block basis (denoted as Intra_{—}8×8) and on a 16×16 macroblock basis (denoted as Intra_{—}16×16). Turning to FIG. 1, MPEG-4 AVC Standard directional intra prediction with respect to a 4×4 block basis (Intra_{—}4×4) is indicated generally by the reference numeral 100. Prediction directions are generally indicated by the reference numeral 110, image blocks are generally indicated by the reference numeral 120, and a current block is indicated by the reference numeral 130. In addition to luma prediction, a separate chroma prediction is performed. There are a total of nine prediction modes for Intra_{—}4×4 and Intra_{—}8×8, four modes for Intra_{—}16×16 and four modes for the chroma component. The encoder typically selects the prediction mode that minimizes the difference between the prediction and original block to be coded. A further intra coding mode, denoted I_PCM, allows the encoder to simply bypass the prediction and transform coding processes. It allows the encoder to precisely represent the values of the samples and place an absolute limit on the number of bits that may be contained in a coded macroblock without constraining decoded image quality.

Turning to FIG. 2, labeling of prediction samples for the Intra_{—}4×4 mode of the MPEG-4 AVC Standard is indicated generally by the reference numeral 200. FIG. 2 shows the samples (in capital letters A-M) above and to the left of the current block which have been previously coded and reconstructed and are therefore available at the encoder and decoder to form the prediction.

Turning to FIGS. 3B-J, Intra_{—}4×4 luma prediction modes of the MPEG-4 AVC Standard are indicated generally by the reference numeral 300. The samples a, b, c, . . . , p of the prediction block are calculated based on the samples A-M using the Intra_{—}4×4 luma prediction modes 300. The arrows in FIGS. 3B-J indicate the direction of prediction for each of the Intra_{—}4×4 modes 300. The Intra_{—}4×4 luma prediction modes 300 include modes 0-8, with mode 0 (FIG. 3B, indicated by reference numeral 310) corresponding to a vertical prediction mode, mode 1 (FIG. 3C, indicated by reference numeral 311) corresponding to a horizontal prediction mode, mode 2 (FIG. 3D, indicated by reference numeral 312) corresponding to a DC mode, mode 3 (FIG. 3E, indicated by reference numeral 313) corresponding to a diagonal down-left mode, mode 4 (FIG. 3F, indicated by reference numeral 314) corresponding to a diagonal down-right mode, mode 5 (FIG. 3G, indicated by reference numeral 315) corresponding to a vertical-right mode, mode 6 (FIG. 3H, indicated by reference numeral 316) corresponding to a horizontal-down mode, mode 7 (FIG. 3I, indicated by reference numeral 317) corresponding to a vertical-left mode, and mode 8 (FIG. 3J, indicated by reference numeral 318) corresponding to a horizontal-up mode. FIG. 3A shows the general prediction directions 330 corresponding to each of the Intra_{—}4×4 modes 300.

In modes 3-8, the predicted samples are formed from a weighted average of the prediction samples A-M. Intra_{—}8×8 uses basically the same concepts as the 4×4 predictions, but with a block size 8×8 and with low-pass filtering of the neighboring reconstructed pixels to improve prediction performance.

Turning to FIGS. 4A-D, four Intra_{—}16×16 modes corresponding to the MPEG-4 AVC Standard are indicated generally by the reference numeral 400. The four Intra_{—}16×16 modes 400 includes modes 0-3, with mode 0 (FIG. 4A, indicated by reference numeral 411) corresponding to a vertical prediction mode, mode 1 (FIG. 4B, indicated by reference numeral 412) corresponding to a horizontal prediction mode, mode 2 (FIG. 4C, indicated by reference numeral 413) corresponding to a DC prediction mode, and mode 3 (FIG. 4D, indicated by reference numeral 414) corresponding to a plane prediction mode. Each 8×8 chroma component of an intra coded macroblock is predicted from previously encoded chroma samples above and/or to the left and both chroma components use the same prediction mode. The four prediction modes are very similar to the Intra_{—}16×16, except that the numbering of the modes is different. The modes are DC (mode 0), horizontal (mode 1), vertical (mode 2) and plane (mode 3).

Thus, in the current intra block coding scheme in the MPEG-4 AVC Standard, for Intra_{—}4×4 and Intra_{—}8×8, a popular method to find the best prediction mode is to compute rate-distortion (RD) costs for 9 pre-defined directions and the best prediction mode is thus selected as the one with the least RD cost. The selected mode is then coded and transmitted to the decoder.

Although intra prediction in accordance with the MPEG-4 AVC Standard can exploit some spatial redundancy within a picture, such prediction only relies on pixels above or to the left of the block which have already been encoded. The spatial distance between the neighboring reconstructed pixels and the pixels to be predicted, especially the ones on the bottom right of the current block, can be large. With a large spatial distance, the correlation between pixels can be low, and the residue signals can be large after prediction, which affects the coding efficiency. In addition, extrapolation is used instead of interpolation because of the limitation of causality.

In a first prior art approach, a new encoding method for the planar mode of Intra_{—}16×16 is proposed. When a macroblock is coded in planar mode, its bottom-right sample is signaled in the bitstream, the rightmost and bottom samples of the macroblock are linearly interpolated, and the middle samples are bi-linearly interpolated from the border samples. When planar mode is signaled, the same algorithm is applied to luminance and both chrominance components separately with individual signaling of the bottom-right samples (using a 16×16 based operation for luminance and an 8×8 based operation for chrominance). The planar mode does not code the residue.

Although the planar prediction method according to the first prior art approach exploits some spatial correlation with the bottom-right sample, the prediction accuracy of the right and bottom pixels are still quite limited.

In a second prior art approach, Bidirectional Intra Prediction (BIP) is proposed to improve the intra coding efficiency. Two features are proposed with respect to BIP as follows: one feature is the bidirectional prediction that combines two unidirectional intra prediction modes; and the other feature is the change of the sub-block coding order in a macroblock. By introducing the bidirectional prediction, BIP increases the total number of prediction modes from 9 to 16. To change the sub-block coding order, it encodes the bottom-right 8×8 (or 4×4) sub-block first before encoding the other three sub-blocks. Whether to change the coding order is an RD cost based decision which needs to be signaled to the decoder.

Although the BIP method greatly improves the coding efficiency, the encoder complexity of this algorithm is very high in the exemplary encoder. For example, the MPEG-4 AVC Standard loops over 9 modes for 8×8 blocks while BIP has to loop over 16*2=32 modes to select the one with the minimum RD cost. BIP also requires more bits to signal the mode and coding order.

In a third prior art approach, a geometric-structure-based directional filtering scheme is proposed for error concealment of a missing block, where the boundary information is always available. The directional filtering scheme makes use of the geometric information extracted from the surrounding pixels and can thus preserve the geometric structure of the missing block. As an application of this error concealment algorithm, a block-dropping-based approach utilizing spatial interpolation at the receiving end to assist low bit rate coding is also proposed therein.

### SUMMARY

These and other drawbacks and disadvantages of the prior art are addressed by the present principles, which are directed to methods and apparatus for geometric-based intra prediction.

According to an aspect of the present principles, an apparatus is provided. The apparatus includes a video encoder for encoding picture data for at least a portion of a block in a picture by detecting a local geometric pattern in a surrounding area with respect to the portion, and performing at least one of interpolation and extrapolation with respect to an edge direction of the local geometric pattern to generate an intra prediction for the portion.

According to another aspect of the present principles, a method is provided in a video encoder. The method includes encoding picture data for at least a portion of a block in a picture by detecting a local geometric pattern in a surrounding area with respect to the portion, and performing at least one of interpolation and extrapolation with respect to an edge direction of the local geometric pattern to generate an intra prediction for the portion.

According to yet another aspect of the present principles, an apparatus is provided. The apparatus includes a video decoder for decoding picture data for at least a portion of a block in a picture by detecting a local geometric pattern in a surrounding area with respect to the portion, and performing at least one of interpolation and extrapolation with respect to an edge direction of the local geometric pattern to generate an intra prediction for the portion.

According to still another aspect of the present principles, a method in a video decoder is provided. The method includes decoding picture data for at least a portion of a block in a picture by detecting a local geometric pattern in a surrounding area with respect to the portion, and performing at least one of interpolation and extrapolation with respect to an edge direction of the local geometric pattern to generate an intra prediction for the portion.

According to a further aspect of the present principles, there is provided a computer readable storage medium having video signal data encoded thereupon. The computer readable storage medium includes picture data for at least a portion of a block in a picture encoded by detecting a local geometric pattern in a surrounding area with respect to the portion, and performing at least one of interpolation and extrapolation with respect to an edge direction of the local geometric pattern to generate an intra prediction for the portion.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram showing MPEG-4 AVC Standard directional intra prediction 100 with respect to a 4×4 block basis (Intra_{—}4×4);

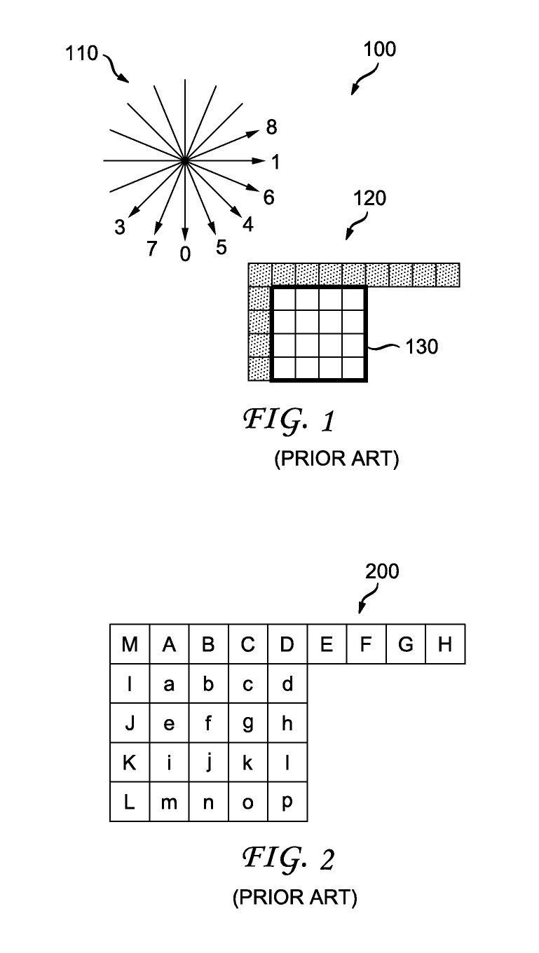

FIG. 2 is a diagram showing labeling 200 of prediction samples for the Intra_{—}4×4 mode of the MPEG-4 AVC Standard;

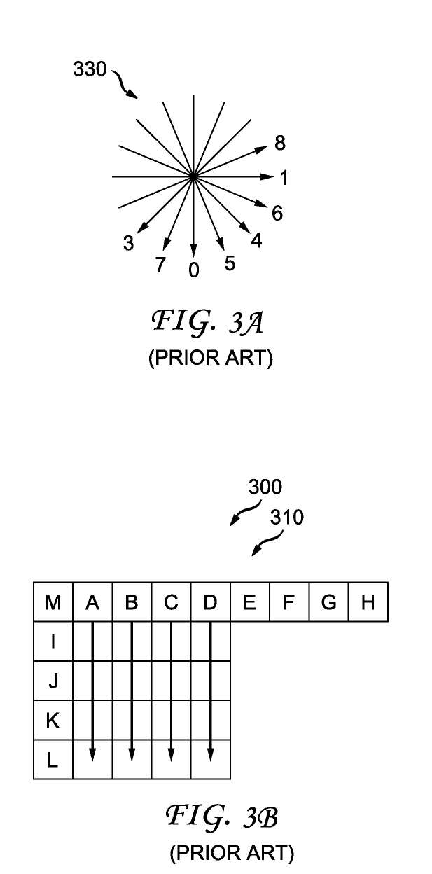

FIGS. 3A-J are diagrams respectively showing Intra_{—}4×4 luma prediction modes of the MPEG-4 AVC Standard;

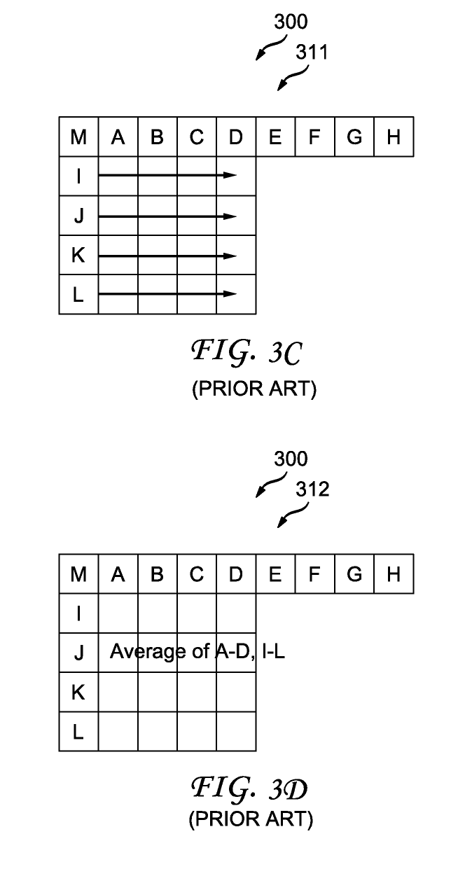

FIGS. 4A-D are diagrams respectively showing four Intra_{—}16×16 modes corresponding to the MPEG-4 AVC Standard;

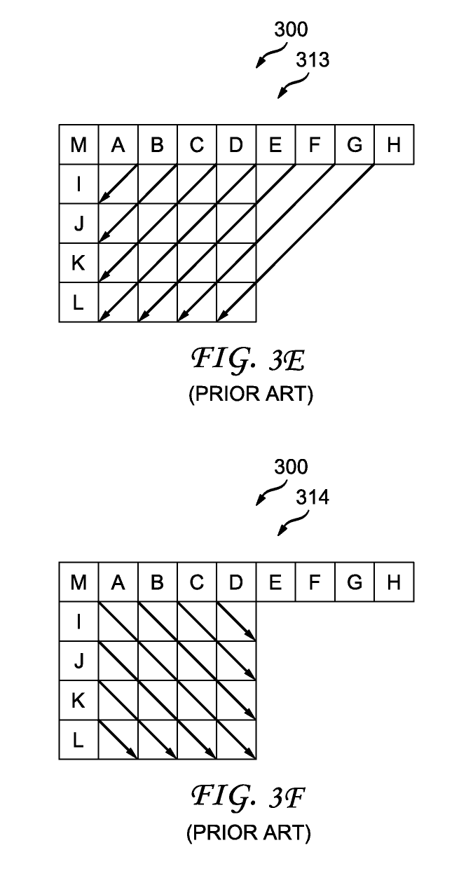

FIG. 5 is a block diagram showing an exemplary video encoder 500 to which the present principles may be applied, in accordance with an embodiment of the present principles;

FIG. 6 is a block diagram showing an exemplary video decoder 600 to which the present principles may be applied, in accordance with an embodiment of the present principles;

FIG. 7A is a block diagram showing an exemplary geometric-based intra prediction 700, where all surrounding areas are available and use interpolation along the detected edge direction, in accordance with an embodiment of the present principles;

FIG. 7B is a block diagram showing another exemplary of geometric-based intra prediction 750, where partial surrounding areas are available and use extrapolation along the detected edge direction, in accordance with an embodiment of the present principles;

FIG. 8 is a flow diagram showing an exemplary method 800 for encoding using geometric-based intra prediction, in accordance with an embodiment of the present principles;

FIG. 9 is a flow diagram showing an exemplary method 900 for decoding using geometric-based intra prediction, in accordance with an embodiment of the present principles;

FIG. 10 is a diagram showing an exemplary transition-based intra prediction 1000, in accordance with an embodiment of the present principles;

FIG. 11 is a diagram showing an exemplary geometric based intra prediction 1100 involving two transitions, in accordance with an embodiment of the present principles;

FIG. 12 is a diagram showing another exemplary geometric based intra prediction 1200 involving two transitions, in accordance with an embodiment of the present principles;

FIG. 13 is a diagram showing an example of a geometric based intra prediction 1300 with four transitions, in accordance with an embodiment of the present principles;

FIG. 14 is a diagram showing an example of a geometric based intra prediction 1400 with four transitions, involving an edge and a streak, in accordance with an embodiment of the present principles;

FIG. 15 is a diagram showing an example of raster coding order 1500, in accordance with the MPEG-4 AVC Standard; and

FIG. 16 is a diagram showing an exemplary reverse coding order 1600, in accordance with an embodiment of the present principles.

### DETAILED DESCRIPTION

The present principles are directed to methods and apparatus for geometric-based intra prediction.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the words “picture” and “image” are used interchangeably and refer to a still image or a picture from a video sequence. As is known, a picture may be a frame or a field.

Additionally, as used herein, the word “signal” refers to indicating something to a corresponding decoder. For example, the encoder may signal a particular block partition coding order in order to make the decoder aware of which particular order was used on the encoder side. In this way, the same order may be used at both the encoder side and the decoder side. Thus, for example, an encoder may transmit a particular order to the decoder so that the decoder may use the same particular order or, if the decoder already has the particular order as well as others, then signaling may be used (without transmitting) to simply allow the decoder to know and select the particular order. By avoiding transmission of any actual orders, a bit savings may be realized. It is to be appreciated that signaling may be accomplished in a variety of ways. For example, one or more syntax elements, flags, and so forth may be used to signal information to a corresponding decoder.

As noted above, the present principles are directed to methods and apparatus for geometric-based intra prediction.

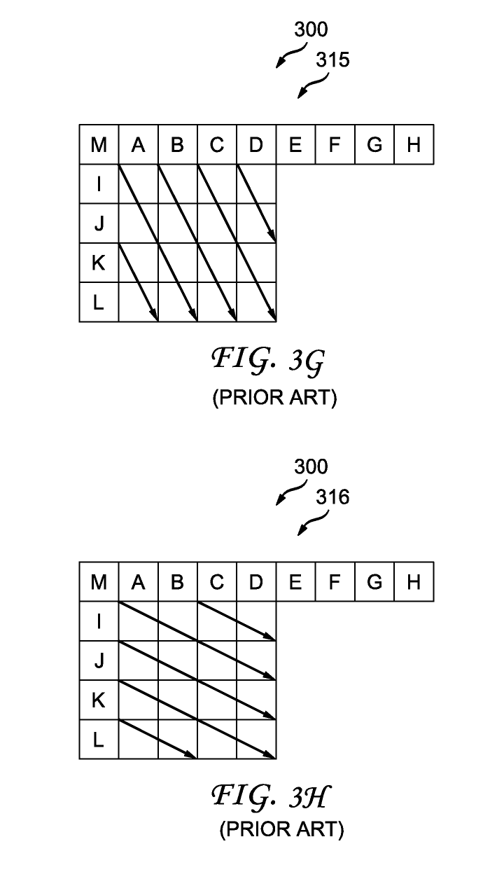

Turning to FIG. 5, an exemplary video encoder to which the present principles may be applied is indicated generally by the reference numeral 500. The video encoder 500 includes a frame ordering buffer 510 having an output in signal communication with a non-inverting input of a combiner 585. An output of the combiner 585 is connected in signal communication with a first input of a transformer and quantizer 525. An output of the transformer and quantizer 525 is connected in signal communication with a first input of an entropy coder 545 and a first input of an inverse transformer and inverse quantizer 550. An output of the entropy coder 545 is connected in signal communication with a first non-inverting input of a combiner 590. An output of the combiner 590 is connected in signal communication with a first input of an output buffer 535.

A first output of an encoder controller 505 is connected in signal communication with a second input of the frame ordering buffer 510, a second input of the inverse transformer and inverse quantizer 550, an input of a picture-type decision module 515, a first input of a macroblock-type (MB-type) decision module 520, a second input of an intra prediction module 560, a second input of a deblocking filter 565, a first input of a motion compensator 570, a first input of a motion estimator 575, and a second input of a reference picture buffer 580.

A second output of the encoder controller 505 is connected in signal communication with a first input of a Supplemental Enhancement Information (SEI) inserter 530, a second input of the transformer and quantizer 525, a second input of the entropy coder 545, a second input of the output buffer 535, and an input of the Sequence Parameter Set (SPS) and Picture Parameter Set (PPS) inserter 540.

An output of the SEI inserter 530 is connected in signal communication with a second non-inverting input of the combiner 590.

A first output of the picture-type decision module 515 is connected in signal communication with a third input of the frame ordering buffer 510. A second output of the picture-type decision module 515 is connected in signal communication with a second input of a macroblock-type decision module 520.

An output of the Sequence Parameter Set (SPS) and Picture Parameter Set (PPS) inserter 540 is connected in signal communication with a third non-inverting input of the combiner 590.

An output of the inverse quantizer and inverse transformer 550 is connected in signal communication with a first non-inverting input of a combiner 519. An output of the combiner 519 is connected in signal communication with a first input of the intra prediction module 560 and a first input of the deblocking filter 565. An output of the deblocking filter 565 is connected in signal communication with a first input of a reference picture buffer 580. An output of the reference picture buffer 580 is connected in signal communication with a second input of the motion estimator 575 and a third input of the motion compensator 570. A first output of the motion estimator 575 is connected in signal communication with a second input of the motion compensator 570. A second output of the motion estimator 575 is connected in signal communication with a third input of the entropy coder 545.

An output of the motion compensator 570 is connected in signal communication with a first input of a switch 597. An output of the intra prediction module 560 is connected in signal communication with a second input of the switch 597. An output of the macroblock-type decision module 520 is connected in signal communication with a third input of the switch 597. The third input of the switch 597 determines whether or not the “data” input of the switch (as compared to the control input, i.e., the third input) is to be provided by the motion compensator 570 or the intra prediction module 560. The output of the switch 597 is connected in signal communication with a second non-inverting input of the combiner 519 and an inverting input of the combiner 585.

A first input of the frame ordering buffer 510 and an input of the encoder controller 505 are available as inputs of the encoder 500, for receiving an input picture. Moreover, a second input of the Supplemental Enhancement Information (SEI) inserter 530 is available as an input of the encoder 500, for receiving metadata. An output of the output buffer 535 is available as an output of the encoder 500, for outputting a bitstream.

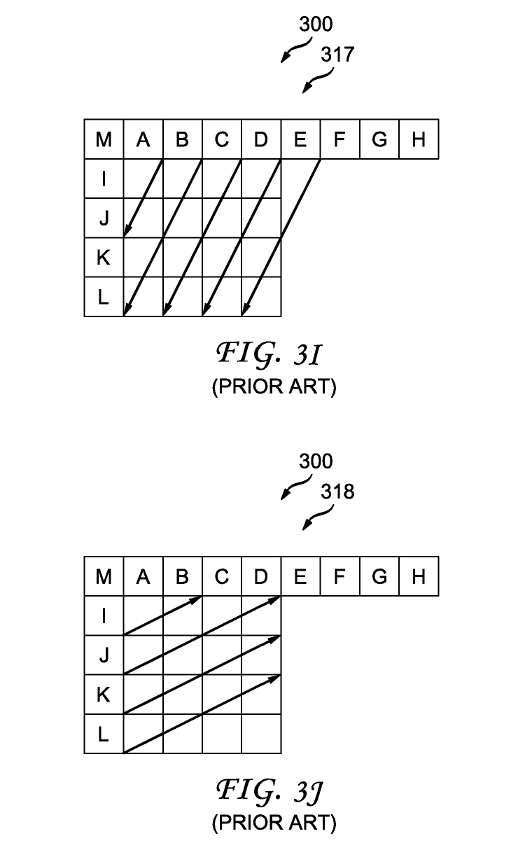

Turning to FIG. 6, an exemplary video decoder to which the present principles may be applied is indicated generally by the reference numeral 600. The video decoder 600 includes an input buffer 610 having an output connected in signal communication with a first input of an entropy decoder 645. A first output of the entropy decoder 645 is connected in signal communication with a first input of an inverse transformer and inverse quantizer 650. An output of the inverse transformer and inverse quantizer 650 is connected in signal communication with a second non-inverting input of a combiner 625. An output of the combiner 625 is connected in signal communication with a second input of a deblocking filter 665 and a first input of an intra prediction module 660. A second output of the deblocking filter 665 is connected in signal communication with a first input of a reference picture buffer 680. An output of the reference picture buffer 680 is connected in signal communication with a second input of a motion compensator 670.

A second output of the entropy decoder 645 is connected in signal communication with a third input of the motion compensator 670, a first input of the deblocking filter 665, and a third input of the intra predictor 660. A third output of the entropy decoder 645 is connected in signal communication with an input of a decoder controller 605. A first output of the decoder controller 605 is connected in signal communication with a second input of the entropy decoder 645. A second output of the decoder controller 605 is connected in signal communication with a second input of the inverse transformer and inverse quantizer 650. A third output of the decoder controller 605 is connected in signal communication with a third input of the deblocking filter 665. A fourth output of the decoder controller 605 is connected in signal communication with a second input of the intra prediction module 660, a first input of the motion compensator 670, and a second input of the reference picture buffer 680.

An output of the motion compensator 670 is connected in signal communication with a first input of a switch 697. An output of the intra prediction module 660 is connected in signal communication with a second input of the switch 697. An output of the switch 697 is connected in signal communication with a first non-inverting input of the combiner 625.

An input of the input buffer 610 is available as an input of the decoder 600, for receiving an input bitstream. A first output of the deblocking filter 665 is available as an output of the decoder 600, for outputting an output picture.

In accordance with the present principles, we propose a novel intra block coding scheme with geometric-based intra prediction (GIP) to improve the intra prediction accuracy and the intra coding efficiency. The prediction direction is derived based on the geometric structure of the neighbor surrounding pixels. The proposed idea is based on the observation that the surrounding pixels on a block boundary are useful in identifying the local geometric pattern, which can be used to derive the intra prediction mode for the current block. Compared to the intra coding of the MPEG-4 AVC Standard which in general loops over all pre-defined prediction directions in the encoder to find the best prediction mode, the present principles significantly reduce the computational complexity at encoder. Moreover, no mode selection is needed and syntax bits indicating intra prediction modes are saved. That is, the same operation is performed at the decoder to derive the prediction mode. Hence, the amount of overhead bits is reduced for mode signaling. In addition, the prediction is not limited to be one of the 9 pre-defined directions. Rather, the prediction can be an arbitrary direction, or a combination of several directions that are derived. To apply the GIP, it can be used as a replacement of an existing intra-prediction mode, or to replace all the 9 prediction modes to save bits.

In addition, we try to improve coding efficiency by using interpolation instead of extrapolation. Moreover, a new coding order is proposed wherein we propose to first encode a partition of the current block, e.g., the rightmost columns and/or the bottom rows of the block. The reconstructed columns and/or rows are then combined with the top and left neighboring blocks that are already encoded to derive the prediction mode of the rest of the current block.

For purposes of illustration and description, examples are described herein in the context of improvements over the MPEG-4 AVC Standard, using the MPEG-4 AVC Standard as the baseline for our description and explaining the improvements and extensions beyond the MPEG-4 AVC Standard. However, it is to be appreciated that the present principles are not limited solely to the MPEG-4 AVC Standard and/or extensions thereof. Given the teachings of the present principles provided herein, one of ordinary skill in this and related arts would readily understand that the present principles are equally applicable and would provide at least similar benefits when applied to extensions of other standards, or when applied and/or incorporated within standards not yet developed. That is, it would be readily apparent to those skilled in the art that other standards may be used as a starting point to describe the present principles and their new and novel elements as changes and advances beyond that standard or any other. It is to be further appreciated that the present principles also apply to video encoders and video decoders that do not conform to standards, but rather confirm to proprietary definitions.

The following steps 1-4 are conducted at both the encoder and the decoder.

### Step 1. Store the Surrounding Areas of a Block Partition

We propose to first store the available surrounding pixels of a block partition to identify the local geometric pattern. As used herein, “available” means pixels that have already been reconstructed and, hence, are able to be used to generate a prediction. The block partition can be a portion of a block (such as, for example, a row, a column, or a sub-block) or the block itself.

In the regular coding order (i.e., raster order), only top and left pixels of the current block partition are available as surrounding pixels for intra prediction. In one embodiment, the surrounding area can be one row on top and one column on the left. In another embodiment, the surrounding area can be two rows on top and two columns on the left. Yet in another embodiment, the surrounding area can be the whole neighboring block partitions on the left and on top.

In the new coding order, a block includes several partitions. The first partition includes pixels from the bottom-right of the current block and it will be encoded first. For the first partition, only left and top pixels from neighboring encoded blocks are available, so the process is the same as in regular coding order. For the remaining partitions of the current block, surrounding pixels may be available from the bottom and the right, in addition to from the top and the left. Thus, the surrounding area can be the outer boundary of that partition, or all the neighboring blocks/partitions.

### Step 2. Analyze the Surrounding Areas to Find Direction

After the surrounding areas are stored, geometric analysis is performed on the areas to find local patterns. In an embodiment, the analysis method can be an edge-detection method such as, for example, but not limited to, a Sobel operator, a Canny operator, thresholding and linking. In another embodiment, the analysis method can be a transition point based analysis, where the local edge is implicitly derived instead of detected. The orientation of a local edge is used as the prediction direction for intra prediction.

### Step 3. Perform Extrapolation/Interpolation to Generate Predictors

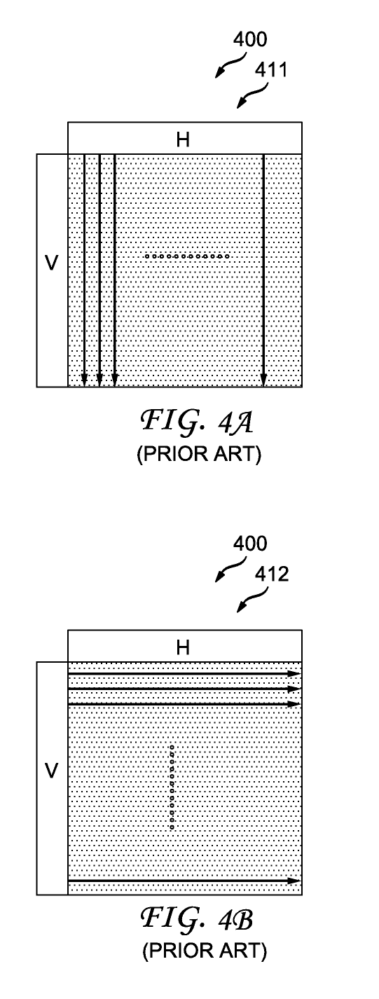

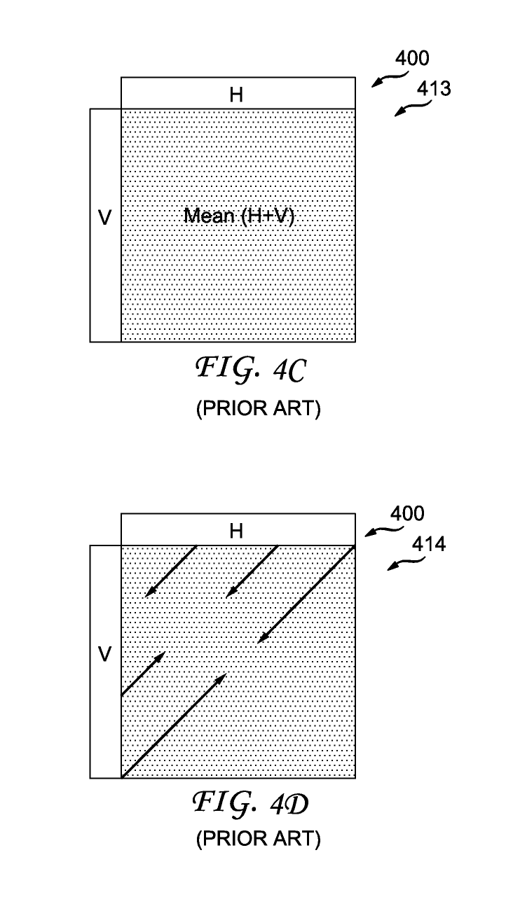

When the direction of the local pattern is found, predicted pixel values are generated by performing extrapolation or interpolation along that direction. The prediction value (predictor) is generated by extrapolation if surrounding pixels are only available on one side of the derived edge direction. Otherwise the predictor is generated by interpolation with surrounding pixels available on both sides of the derived edge direction. Turning to FIG. 7A, an exemplary geometric-based intra prediction is indicated generally by the reference numeral 700. With respect to the geometric-based intra prediction 700, all surrounding areas are available and, thus, interpolation is used along the detected edge direction. Turning to FIG. 7B, another exemplary geometric-based intra prediction is indicated generally by the reference numeral 750. With respect to the geometric-based intra prediction 750, only partial surrounding areas (on the left and on the top) are available and, thus, extrapolation is used along the detected edge direction.

### Step 4. Generate Residues on Encoder/Decoder

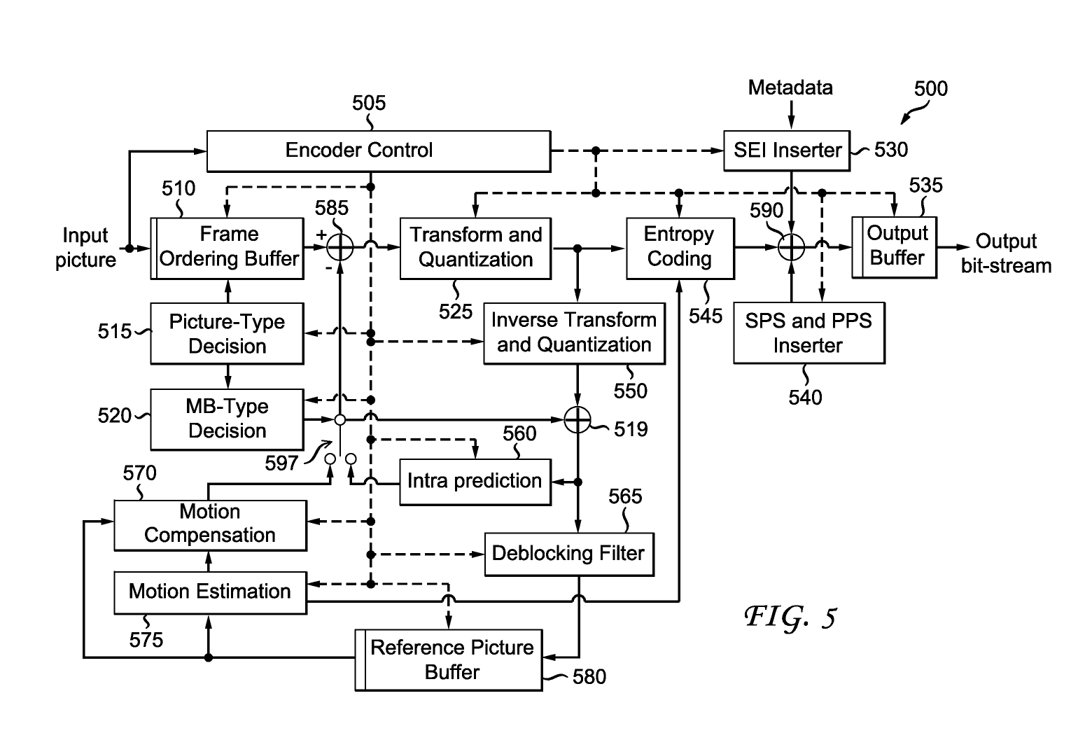

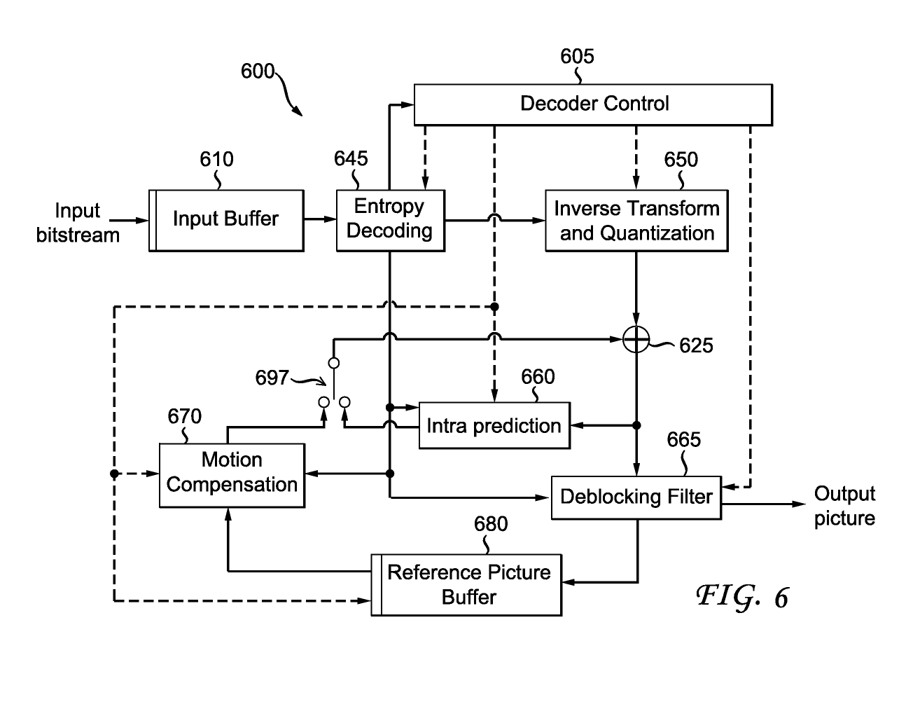

When a predictor is generated, the encoder will generate the residues by subtraction. Spatial domain and/or frequency domain transforms are conducted to calculate coefficients. Entropy encoding is performed to further improve the coding efficiency. RD cost is compared between regular coding order and new coding order, and the final decision of a coding order with smaller rate-distortion (RD) cost will be signaled and transmitted to the bitstream (see FIG. 8). The decoder will decode the coding order and residues from the bitstream to generate the reconstructed pixel values by performing the summation process (see FIG. 9).

Turning to FIG. 8, an exemplary method for encoding using geometric-based intra prediction is indicated generally by the reference numeral 800. The method 800 includes a start block 805 that passes control to a function block 810. The function block 810 performs an encoding setup, and passes control to a loop limit block 815. The loop limit block 815 performs a loop over each block, and passes control to a function block 820. The function block 820 encodes with regular coding order, stores the surrounding areas, analyzes a geometric pattern(s), performs prediction by extrapolation, saves the RD cost, and passes control to a function block 825. The function block 825 encodes with a new coding order, first encodes the bottom-right partition, then encodes the upper-left partition, stores the surrounding areas, analyzes a geometric pattern(s), performs prediction by extrapolation/interpolation, saves the RD cost, and passes control to a function block 830. The function block 830 chooses an order with the minimum RD cost, encodes the residue, signals the coding order, and passes control to a loop limit block 835. The loop limit block 835 ends the loop, and passes control to an end block 899.

Turning to FIG. 9, an exemplary method for decoding using geometric-based intra prediction is indicated generally by the reference numeral 900. The method 900 includes a start block 905 that passes control to a loop limit block 910. The loop limit block 910 performs a loop over each block, and passes control to a decision block 915. The decision block 915 determines whether to perform a regular order or a new order. If a regular order is to be performed, then the method proceeds to a function block 925. Otherwise, the method proceeds to a function block 945. The function block 925 stores surrounding areas, analyzes a geometric pattern(s), performs prediction by extrapolation, and passes control to a function 930. The function block 930 decodes the residue, generates reconstruction pixels, and passes control to a loop limit block 935. The loop limit block ends the loop, and passes control to an end block 999. The function block 945, for the bottom-right partition, stores the surrounding areas, analyzes a geometric partition(s), performs prediction by extrapolation, and passes control to a function block 950. The function block 950, for the upper-left partition, stores the surrounding areas, analyzes a geometric partition(s), performs prediction by interpolation, and passes control to the function block 930.

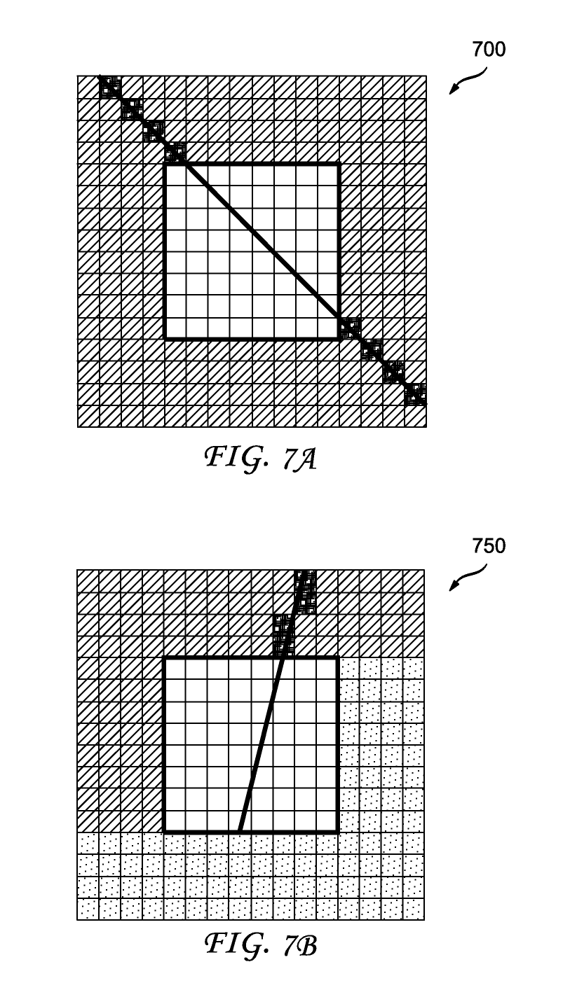

An embodiment of the present principles will now be described directed to transition-based intra prediction (TIP). Turning to FIG. 10, an exemplary transition-based intra prediction is indicated generally by the reference numeral 1000. The surrounding areas of the TIP 1000 are two layers of pixels, namely an inner layer 1010 and an outer layer 1020, surrounding the current block partition 1005. That is, in order to find the local geometric structure along a block boundary, the two nearest surrounding boundary layers are examined. The two layers of pixels are first converted into a binary pattern. The binarization threshold is adaptively chosen based on the statistics of the pixel values on the layers. Several methods can be used for calculating the threshold including, but not limited to, the simplest mean pixel value of boundary layers, the average of the fourth largest value and the fourth smallest value, and most complicated histogram based segmentation. Pixels that are larger than the threshold are marked as white and smaller black. After binarization, a three point median filter is applied to eliminate isolated black or white points.

A transition point is defined where there is a transition from black to white or white to black in the clockwise direction on each layer. For example, in FIG. 10, the dots (1011 and 1012) on the inner layer 1010 and dots (1021 and 1022) on the outer layer 1020 indicate the transition points. A transition point (1011 and 1012) on the inner layer 1010 indicates the location of an edge (e.g., an edge crossing), and a transition point (1021 and 1022) on the outer layer 1020 helps to identify the direction of the edge (and, hence, helps to identify the angle of that edge). Note that the number of transition points is always even.

The sudden change of neighboring pixel values forms a transition. A transition from black to white (or vice versa) reveals the existence of an edge. Given the transition distribution on a block boundary, we can analyze the local geometric patterns within the block. Intra prediction thus benefits from the local geometric patterns.

Depending on the number of transition points on the inner layer 1010, the situation is classified into the following four exemplary cases: flat (0 transition); 2 transitions; 4 transitions; and more than 4 transitions. A measure of directional consistency is used to resolve the ambiguity about how the transition points on the inner layer 1010 should be matched to each other to illustrate the local edge structure. An assumption for the local geometric pattern is as follows: If there is an edge passing through transition points i and j, then θᵢⱼ, θᵢ and θⱼ should be consistent. A cost function is introduced as follows:

Cᵢⱼ=|θᵢ−θᵢⱼ|+|θⱼ−θᵢⱼ|

where i and j are the i-th and j-th transitions points, respectively. In the clockwise direction, for the i-th transition point on the inner layer 1010, denote the angle of the line connecting this point and its corresponding transition point on the outer layer θᵢ. The angle of the line connecting the i-th transition point and the j-th point on the inner layer 1010 is denoted θᵢⱼ (see FIG. 10).

When not all surrounding pixels are available, for example, when transition points 1012 and 1022 are not available in FIG. 10, the direction derived from 1011 and 1021 (namely θ₁) may be used as the prediction direction and intra prediction can be performed using extrapolation.

### Flat/Zero Transition

When the binarization threshold is too close to the maximum and minimum pixel value, or the local variance is relatively small, the current block is a smooth block. In this case, the best orientation may be found using existing methods. Given the best orientation, the intra predictors I(p) at pixel p can be generated by bilinear interpolation along that orientation as follows:

$${I}_{p} = \frac{{d}_{2}}{{d}_{1} + {d}_{2}} {p}_{1} + \frac{{d}_{1}}{{d}_{1} + {d}_{2}} {p}_{2}$$

where p1 and p2 are linearly interpolated from their two nearest neighboring pixels on the inner layer 1010, and d1, d2 are the Euclidean distances of p with respect to p1 and p2, respectively.

### Two Transitions

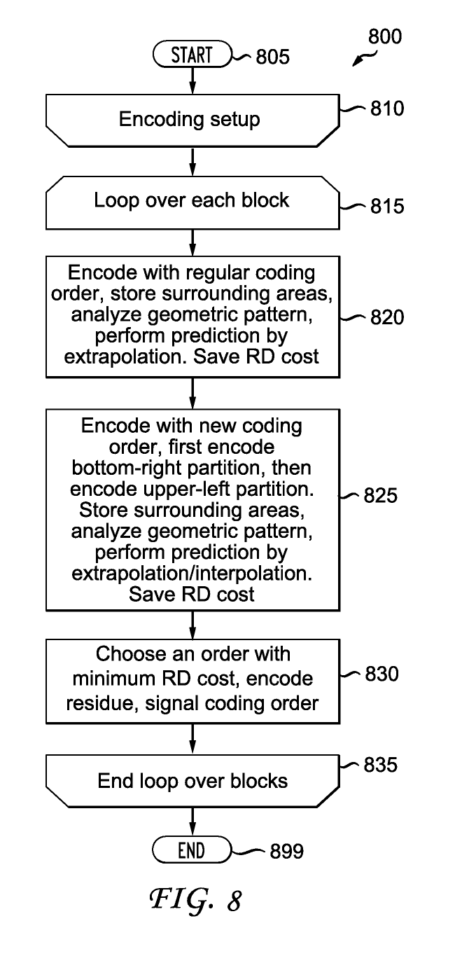

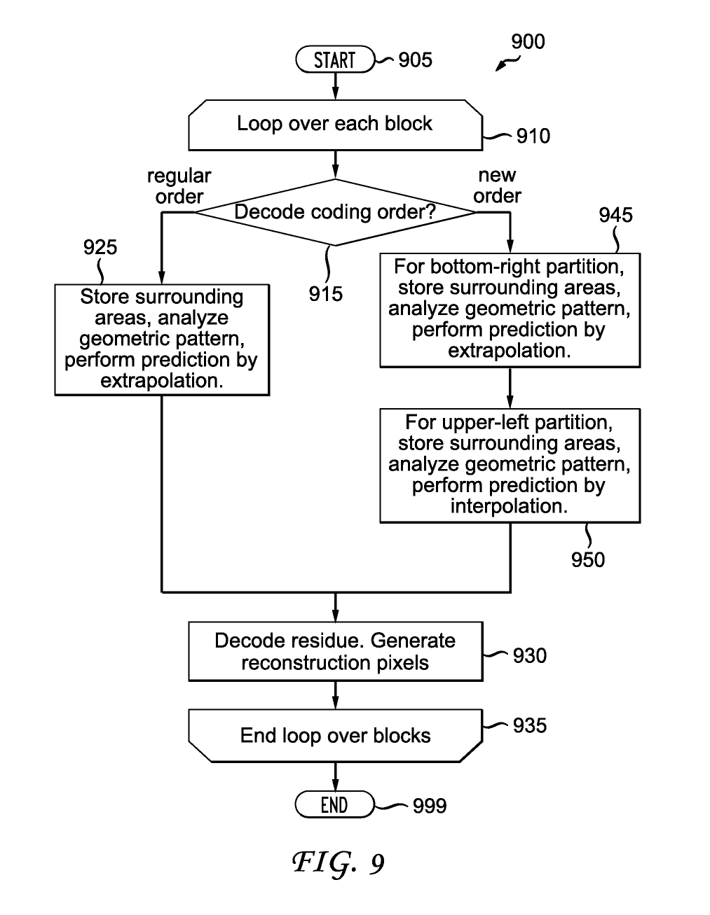

For two transition points, there are two scenarios. The first scenario is that an edge goes through the two transition points (see FIG. 11). This is the most likely case. The other is that a streak or corner exists (see FIG. 12). The interpolation schemes are slightly different for these two scenarios. The decision is based on the cost of transition pairs. If C₀₁<3π/4, then an edge exists. The predictors are generated using bilinear interpolation along θ₀₁. Otherwise, a streak or corner exists and the interpolation is along θ=(θ₀+θ₁)/2.

Turning to FIG. 11, an exemplary geometric based intra prediction involving two transitions is indicated generally by the reference numeral 1100. In the example of FIG. 11, an edge 1120 goes through two transitions 1111 and 1112. Turning to FIG. 12, another exemplary geometric based intra prediction involving two transitions is indicated generally by the reference numeral 1200. In the example of FIG. 12, a streak or corner exists with respect to the two transitions 1211 and 1212.

### Four Transitions

The case of four transitions is more complex than the case of two transitions.

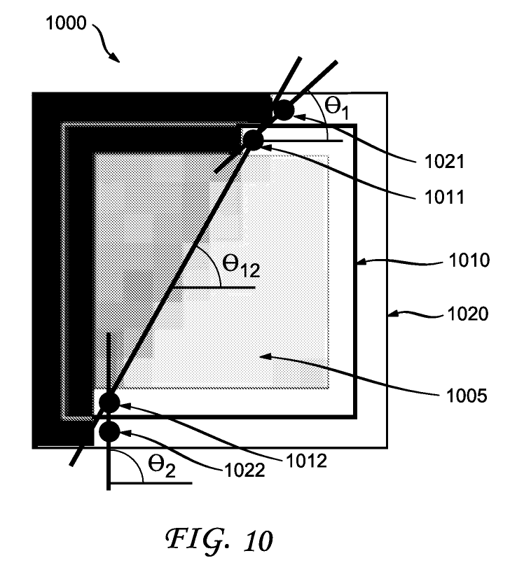

In a four transitions case, denote the transition points starting from the top in the clockwise direction as 0, 1, 2, 3 on the inner layer (also denoted by the reference numerals 1320, 1321, 1322, and 1323 in FIG. 13). There are several situations as follows.

In a first situation, C₀₁+C₂₃<C₀₃+C₂₁, and Cᵢⱼ is not equal to π. When this is true, it is assumed that transition point 0 is connected to transition point 1.

In a second situation, C₀₁+C₂₃>C₀₃+C₂₁, and Cᵢⱼ is not equal to π. In this situation, transition point 0 is connected to transition point 3 (see FIG. 13). For these two situations (the first and the second)), the two edges divide the block into three regions. The bilinear interpolation for each pixel is along the direction of the edge that is closer to the pixel. Turning to FIG. 13, an example of a geometric based intra prediction with four transitions, is indicated generally by the reference numeral 1300.

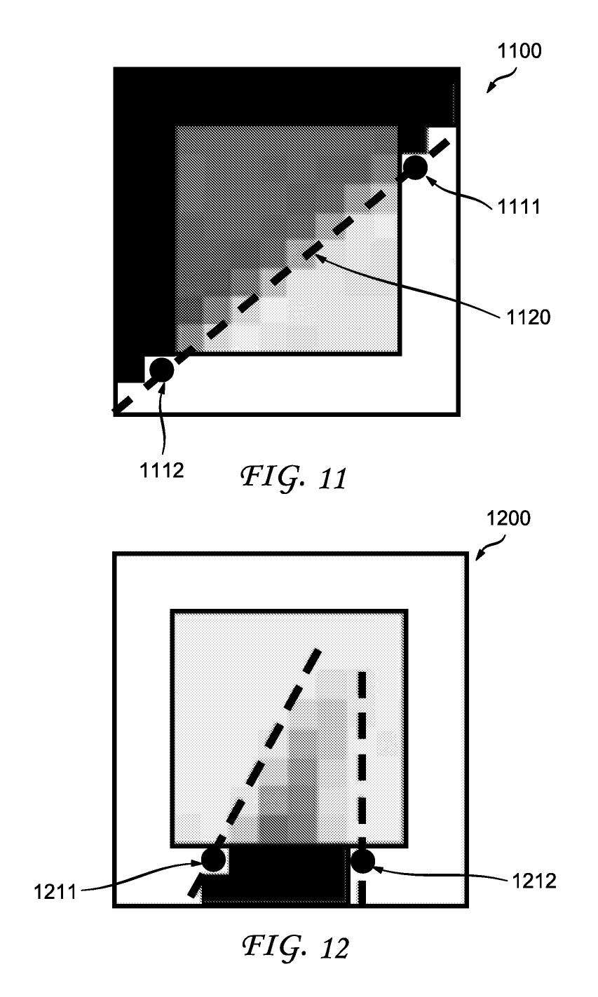

In a third situation, Cᵢⱼ is close to π. It is assumed a strong edge with another narrow streak goes into and stops in the block (see FIG. 14). In this case, every pixel is first bi-linearly interpolated along the direction of the edge, and then the pixels in the streak are interpolated along the direction of the streak. Turning to FIG. 14, an example of a geometric based intra prediction with four transitions, involving an edge and a streak, is indicated generally by the reference numeral 1400. In FIG. 14, the transition points starting from the top in the clockwise direction are denoted by the reference numerals 1420, 1421, 1422, and 1423.

### Six and More Transitions

When six or more than six transition points are found, to discover the optimal combination of edges is complex and difficult. In practice, we analyze the distribution of transition cases with several benchmark video sequences. The result shows that cases with six and more transition points are rare. A simple interpolation scheme is used without severely degrade the overall performance as follows: we select the most frequent direction as the dominant direction. All the predictors are generated bi-linearly along that direction.

With the aforementioned transition point analysis and interpolation schemes, we are able to generate all the predictors for intra prediction. The residues are then encoded and sent to the bitstream. Since the prediction direction is derived by the algorithm itself, no syntax bits are needed to explicitly signal the TIP mode.

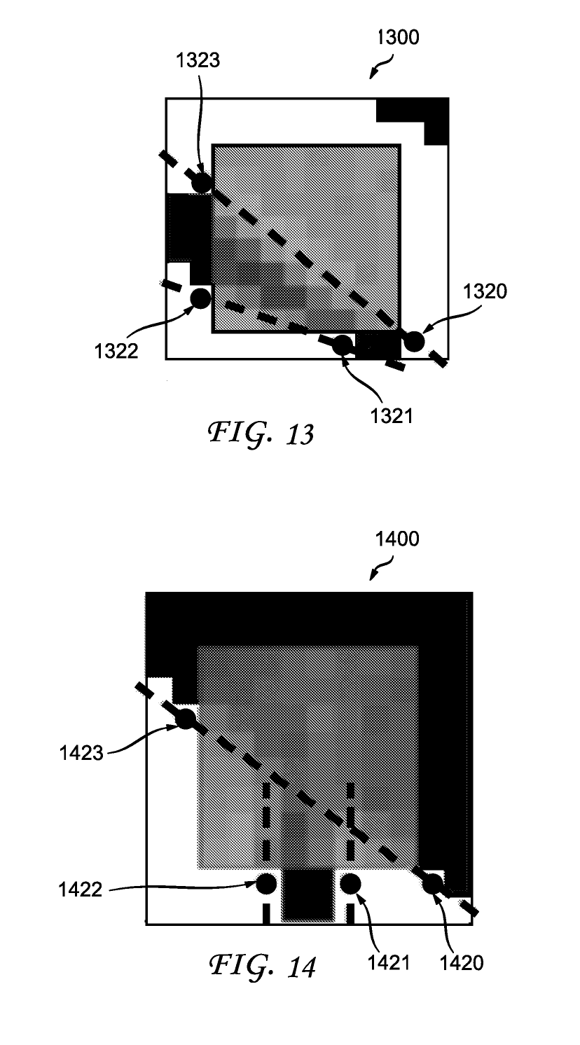

New Encoding Order In the MPEG-4 AVC Standard coding framework, only the blocks on the top or to the left of the current block are available with the raster encoding order. Turning to FIG. 15, an example of raster coding order is indicated generally by the reference numeral 1500.

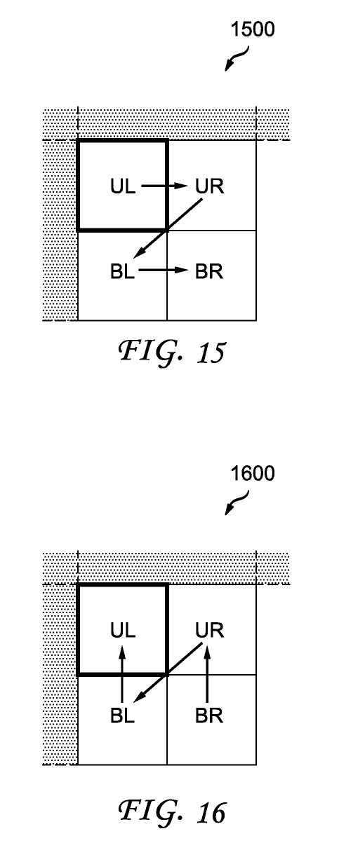

In order to make all surrounding pixels available for the TIP mode, we incorporated a reverse encoding order. Turning to FIG. 16, an exemplary reverse coding order is indicated generally by the reference numeral 1600. For a macroblock, the bottom right (BR) 8×8 block will be encoded first using the top and left neighboring macroblock pixels. Next, the upper right (UR) 8×8 block is encoded using the top and left neighboring macroblock pixels and the reconstructed BR block as well. Then, the bottom left (BL) 8×8 block is encoded using the top and left neighboring macroblock pixels, the BR and UR block. Finally, the upper left (UL) 8×8 block is coded by TIP mode with all its surrounding pixels available.

The encoder will choose the encoding order with corresponding modes under the rate-distortion optimization criteria.

A description will now be given of some of the many attendant advantages/features of the present invention, some of which have been mentioned above. For example, one advantage/feature is an apparatus having a video encoder for encoding picture data for at least a portion of a block in a picture by detecting a local geometric pattern in a surrounding area with respect to the portion, and performing at least one of interpolation and extrapolation with respect to an edge direction of the local geometric pattern to generate an intra prediction for the portion.

Another advantage/feature is the apparatus having the video encoder as described above, wherein the local geometric pattern is detected using at least one of an edge detection method and a transition point based analysis.

Yet another advantage/feature is the apparatus having the video encoder as described above, wherein extrapolation is used to generate the intra prediction for the portion when only pixels on one side of the edge direction are available, and interpolation is used to generate the intra prediction for the portion when pixels on both sides of the edge direction are available.

Still another advantage/feature is the apparatus having the video encoder as described above, wherein the local geometric pattern is detected by examining two nearest surrounding boundary pixel layers with respect to the portion.

Further, another advantage/feature is the apparatus having the video encoder as described above, wherein at least one of a plurality of different interpolation schemes is selectively used depending on a number of transition points detected in the local geometric pattern.

Also, another advantage/feature is the apparatus having the video encoder as described above, wherein the edge direction is used as a prediction direction for the intra prediction.

Additionally, another advantage/feature is the apparatus having the video encoder as described above, wherein the picture data for the block is encoded by initially encoding a bottom-right partition of the block, and subsequently encoding a top-left partition of the block.

Moreover, another advantage/feature is the apparatus having the video encoder wherein the picture data for the block is encoded by initially encoding a bottom-right partition of the block, and subsequently encoding a top-left partition of the block as described above, wherein a partition coding order of the block comprises, in order of first to last, the bottom-right partition, a top-right partition, a bottom left partition, and the top-left partition.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a video encoder for encoding picture data for at least a portion of a block in a picture by detecting a local geometric pattern in a surrounding area with respect to the portion, and performing at least one of interpolation and extrapolation with respect to an edge direction of the local geometric pattern to generate an intra prediction for the portion.

2. The apparatus of claim 1, wherein the local geometric pattern is detected using at least one of an edge detection method and a transition point based analysis.

3. The apparatus of claim 1, wherein extrapolation is used to generate the intra prediction for the portion when only pixels on one side of the edge direction are available, and interpolation is used to generate the intra prediction for the portion when pixels on both sides of the edge direction are available.

4. The apparatus of claim 1, wherein the local geometric pattern is detected by examining two nearest surrounding boundary pixel layers with respect to the portion.

5. The apparatus of claim 1, wherein at least one of a plurality of different interpolation schemes is selectively used depending on a number of transition points detected in the local geometric pattern.

6. The apparatus of claim 1, wherein the edge direction is used as a prediction direction for the intra prediction.

7. The apparatus of claim 1, wherein the picture data for the block is encoded by initially encoding a bottom-right partition of the block, and subsequently encoding a top-left partition of the block.

8. The apparatus of claim 7, wherein a partition coding order of the block comprises, in order of first to last, the bottom-right partition, a top-right partition, a bottom left partition, and the top-left partition.

9. In a video encoder, a method, comprising:
encoding picture data for at least a portion of a block in a picture by detecting a local geometric pattern in a surrounding area with respect to the portion, and performing at least one of interpolation and extrapolation with respect to an edge direction of the local geometric pattern to generate an intra prediction for the portion.

10. The method of claim 9, wherein the local geometric pattern is detected using at least one of an edge detection method and a transition point based analysis.

11. The method of claim 9, wherein extrapolation is used to generate the intra prediction for the portion when only pixels on one side of the edge direction are available, and interpolation is used to generate the intra prediction for the portion when pixels on both sides of the edge direction are available.

12. The method of claim 9, wherein the local geometric pattern is detected by examining two nearest surrounding boundary pixel layers with respect to the portion.

13. The method of claim 9, wherein at least one of a plurality of different interpolation schemes is selectively used depending on a number of transition points detected in the local geometric pattern.

14. The method of claim 9, wherein the edge direction is used as a prediction direction for the intra prediction.

15. The method of claim 9, wherein the picture data for the block is encoded by initially encoding a bottom-right partition of the block, and subsequently encoding a top-left partition of the block.

16. The method of claim 15, wherein a partition coding order of the block comprises, in order of first to last, the bottom-right partition, a top-right partition, a bottom left partition, and the top-left partition.

17. An apparatus, comprising:
a video decoder for decoding picture data for at least a portion of a block in a picture by detecting a local geometric pattern in a surrounding area with respect to the portion, and performing at least one of interpolation and extrapolation with respect to an edge direction of the local geometric pattern to generate an intra prediction for the portion.

18. The apparatus of claim 17, wherein the local geometric pattern is detected using at least one of an edge detection method and a transition point based analysis.

19. The apparatus of claim 17, wherein extrapolation is used to generate the intra prediction for the portion when only pixels on one side of the edge direction are available, and interpolation is used to generate the intra prediction for the portion when pixels on both sides of the edge direction are available.

20. The apparatus of claim 17, wherein the local geometric pattern is detected by examining two nearest surrounding boundary pixel layers with respect to the portion.

21. The apparatus of claim 17, wherein at least one of a plurality of different interpolation schemes is selectively used depending on a number of transition points detected in the local geometric pattern.

22. The apparatus of claim 17, wherein the edge direction is used as a prediction direction for the intra prediction.

23. The apparatus of claim 17, wherein the picture data for the block is encoded by initially encoding a bottom-right partition of the block, and subsequently encoding a top-left partition of the block.

24. The apparatus of claim 23, wherein a partition coding order of the block comprises, in order of first to last, the bottom-right partition, a top-right partition, a bottom left partition, and the top-left partition.

25. In a video decoder, a method, comprising:
decoding picture data for at least a portion of a block in a picture by detecting a local geometric pattern in a surrounding area with respect to the portion, and performing at least one of interpolation and extrapolation with respect to an edge direction of the local geometric pattern to generate an intra prediction for the portion.

26. The method of claim 25, wherein the local geometric pattern is detected using at least one of an edge detection method and a transition point based analysis.

27. The method of claim 25, wherein extrapolation is used to generate the intra prediction for the portion when only pixels on one side of the edge direction are available, and interpolation is used to generate the intra prediction for the portion when pixels on both sides of the edge direction are available.

28. The method of claim 25, wherein the local geometric pattern is detected by examining two nearest surrounding boundary pixel layers with respect to the portion.

29. The method of claim 25, wherein at least one of a plurality of different interpolation schemes is selectively used depending on a number of transition points detected in the local geometric pattern.

30. The method of claim 25, wherein the edge direction is used as a prediction direction for the intra prediction.

31. The method of claim 25, wherein the picture data for the block is encoded by initially encoding a bottom-right partition of the block, and subsequently encoding a top-left partition of the block.

32. The method of claim 31, wherein a partition coding order of the block comprises, in order of first to last, the bottom-right partition, a top-right partition, a bottom left partition, and the top-left partition.

33. A computer readable storage medium having video signal data encoded thereupon, comprising:
picture data for at least a portion of a block in a picture encoded by detecting a local geometric pattern in a surrounding area with respect to the portion, and performing at least one of interpolation and extrapolation with respect to an edge direction of the local geometric pattern to generate an intra prediction for the portion.
